(19) United States
(12) Patent Application Publication
(10) Pub. No.: US 2008/0280499 A1
(43) Pub. Date: Nov. 13, 2008

(54) Jack

(75) Inventors: Kenji Miki, Yao-shi (JP); Koji Matsumoto, Yao-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: HOSIDEN CORPORATION, Yao-shi (JP)

(21) Appl. No.: 11/998,840

(22) Filed: Nov. 30, 2007

(30) Foreign Application Priority Data
Dec. 25, 2006 (JP) JP2006-347451

(51) Int. Cl. H01R 24/04

(52) U.S. Cl. 439/668

(57) ABSTRACT

A jack having enhanced reliability and strength against torsional forces is provided. The jack including a plug inlet for receiving a plug having at least one electrode formed thereon for electrical signals, comprises an elongated spring having a free end part with a pressing portion capable of pressing a side surface of the inserted plug, and a proximal end part fixed to the jack. The jack further comprises a retaining portion capable of contacting a first contact portion and a second contact portion arranged at opposite sides thereof along a direction of inserting the plug when the plug is inserted into the jack.

### BACKGROUND OF THE INVENTION

1. Field of the Invention

The present invention relates to a jack comprising a spring provided along a plug inlet formed in a jack body.

2. Description of the Related Art

One example of conventional jacks used in audio devices or the like comprises a plug inlet formed in a jack body for receiving a plug, and a plurality of electrodes formed of a conductor and arranged inside the plug inlet. Such a jack allows a plurality of conductive surfaces (connecting terminals) formed on the plug and acting as the connecting terminals for the plug to contact the electrodes provided inside the plug inlet when the plug is inserted into the plug inlet. Each of the electrodes provided inside the plug inlet has a spring-shape so as to contact a conductive surface of the plug by its own action when the plug is inserted, and is formed by press working.

Such a jack having the above-noted construction is used as a connecting element for connecting headphones or earphones to a mobile audio device or mobile phone. When the mobile audio device is operated, the user not only holds the mobile audio device with one hand while controlling a play button or the like provided on the mobile audio device with the other hand, but also holds the mobile audio device and controls the buttons with one hand. Such operations sometimes place the relative posture between the plug and jack in an unstable condition, as a result of which the plug is likely to be removed from the jack. Otherwise such an unstable posture produces a torsional force exerted on the jack. Repeatedly producing the torsional force often leads to poor contact between the connecting terminals formed on the plug and the electrodes provided in the jack.

As a countermeasure against such a torsional force, Japanese Unexamined Patent Publication No. 2000-340311 discloses a connector comprising an electrode with a bent portion for allowing a distal end of the electrode or a back contact to contact a plug thereby preventing the distal end of the electrode or the back contact from being excessively displaced by the torsional force (see paragraph 0021, 0029, 0033, 0037 and so on). Also, Japanese Utility Model Application Laid-Open Publication No. 56-62680 discloses a jack comprising a projection such as a boss formed on a body for contacting an electrode thereby preventing excessive displacement (see page 2, FIGS. 4 to 6). However, the above-noted conventional connector or jack has not the least possibility of a contact failure caused by deterioration of the bent electrode or damage of the boss per se resulting from a repetition of torsional forces.

### SUMMARY OF THE INVENTION

The present invention has been made having regard to the above-noted problems, and its object is to provide a jack having enhanced reliability and strength against torsional forces.

In order to achieve the above-noted object, a jack in accordance with the present invention comprises a plug inlet for receiving a plug having at least one electrode formed therein for electrical signals, and an elongated spring. The elongated spring has a pressing portion formed in a free end part thereof for pressing a side surface of the plug, and a proximal end part fixed to the jack. The jack also comprises a retaining portion capable of contacting a first contact portion and a second contact portion provided at opposite sides of the pressing portion of the free end part along a direction of inserting the plug when the plug is inserted into the jack.

With this arrangement, in addition to the pressing portion provided in the spring pressing the side surface of the plug inserted into the jack, the retaining portion can support the first contact portion and second contact portion of the spring. This can increase a pressing force of the spring. As a result, a retaining force for the jack to support the plug can be enhanced thereby preventing the plug coming off inadvertently to the user.

It is also preferable that the jack further comprises a guide mechanism for preventing out-of-plane displacement of the pressing portion from a predetermined rocking plane defined by the spring rockable about the proximal end part when the plug is inserted into the jack. With this guide mechanism provided for the spring and jack, the pressing portion is prevented from displacing from the side surface of the plug to be pressed even if a torsional force is exerted on the jack or the plug. Thus, the plug can be reliably pressed.

It is also preferable that the guide mechanism includes a projection provided in the jack and extending through an opening formed in the spring. This arrangement can improve the effect produced by the guide mechanism.

Further, the projection may be formed along an extending direction of the plug inlet, and the retaining portion may be formed on an outer surface of the projection. This arrangement makes it possible to simply form the guide mechanism and a retainer mechanism having the retaining portion. Thus, the jack can be efficiently manufactured.

Further, it is preferable that the spring is an electrode electrically connectable to the plug. Where the spring acts as an electrode of the jack for connection with the electrodes formed on the plug, the spring can have a function as the electrode and a pressing function. As a result, the jack has a compact construction which is less subject to influences of a torsional force, and also improves reliability of electrical connection.

### BRIEF DESCRIPTION OF THE DRAWINGS

FIG. 1 is a perspective view of a plug and a jack for connecting a mobile audio device to earphones;

FIG. 2 is a perspective view of the plug and the jack;

FIG. 3 is an exploded view showing terminal electrodes forming the jack;

FIG. 4 is a perspective view showing a relationship between the jack and an earth spring;

FIG. 5 is a view showing how the earth spring is retained;

FIG. 6 is a circuit diagram showing connections among the terminal electrodes of the jack;

FIG. 7 is a bottom view of the jack;

FIG. 8 is a sectional view of the jack taken along line VIII-VIII of FIG. 7;

FIG. 9 is a sectional view of the jack taken along line IX-IX of FIG. 7;

FIG. 10 is a perspective view of an earth spring in accordance with an alternative embodiment of the present invention; and

FIG. 11 is a view showing how the earth spring is retained in accordance with the alternative embodiment of the present invention.

### DESCRIPTION OF THE PREFERRED EMBODIMENT

Embodiments of a jack in accordance with the present invention will be described hereinafter with reference to the accompanying drawings.

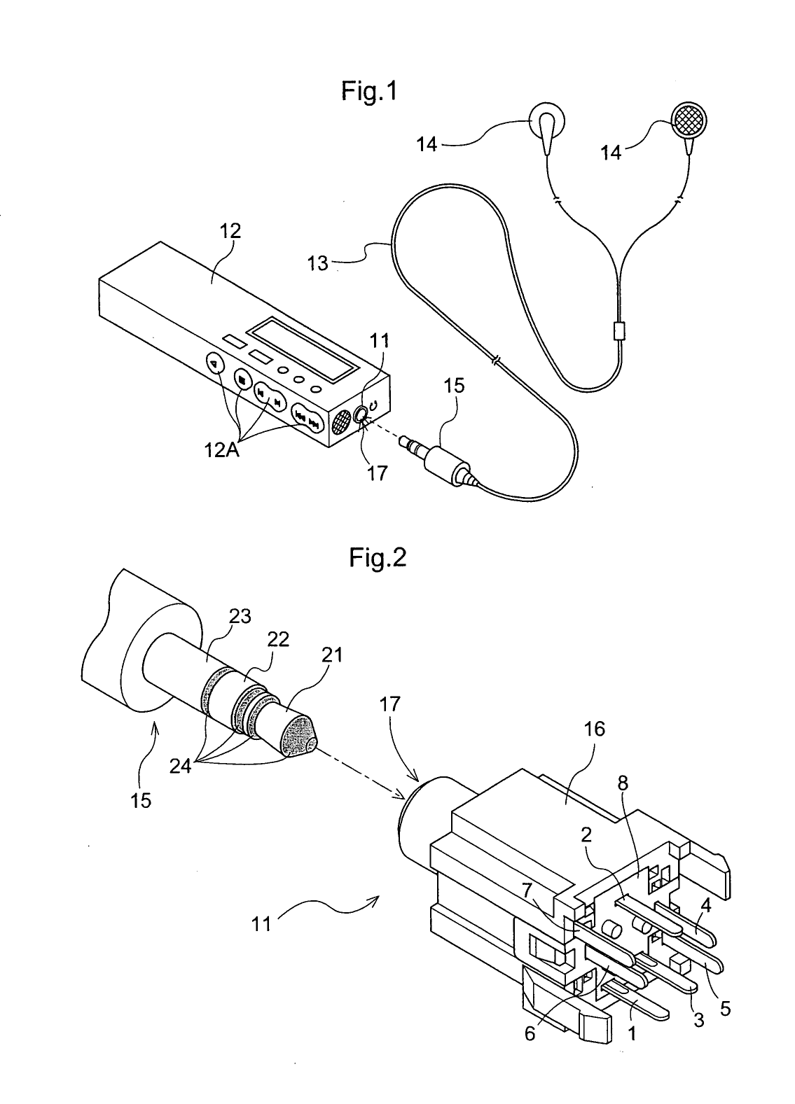

A jack 11 is provided in a mobile audio device 12 as shown in FIG. 1, and includes a plug inlet 17 for receiving a plug 15 connected to a pair of stereo-type earphones 14 or headphones (not shown) through a cable 13. Such a mobile audio device 12 includes a plurality of control switches 12A operable to play and stop audio data stored in the device 12 and further to control the volume of sound. In the present embodiment, the jack 11 will be described as provided in the mobile audio device 12. However, the scope of the present invention is not limited to such an application. The jack 11 in accordance with the present invention may be used in mobile phones or mounted on other electric appliances.

FIG. 2 shows the plug 15 insertable into the jack 11 of the present invention. The plug 15 includes a tip 21 provided at a distal end thereof to act as an electrode for stereo audio signals outputted to the left earphone. The plug 15 further includes a ring 22 acting as an electrode for stereo audio signals outputted to the right earphone, and a sleeve 23, the ring 22 and the sleeve 23 being arranged in the mentioned order from adjacent the distal end of the plug. Insulating rings 24 are mounted between the tip 21 and the ring 22 for insulating one from the other. A further insulating ring 24 is provided between the ring 22 and the sleeve 23 as well. The sleeve 23 is connected to a shield layer used for protecting the right and left stereo audio signals from outside noise in the cable 13. Thus, the tip 21 and ring 22 are connected to the jack for transmitting audio signals from the mobile audio device 12 to the earphones 14 through the cable 13. The sleeve 23 is connected to have the same potential as the ground of the mobile audio device 12.

The plug inlet 17 is provided in a body 16 of the jack 11 for receiving the plug 15. Outside of the body 16 (the side facing away from the plug inlet 17 in FIG. 2) are provided a plurality of terminal electrodes 1 to 7 connected to a plurality of electrodes provided inside the body, respectively. These terminal electrodes 1 to 7 are insulated from one another by a separator 8 formed of an insulating material for preventing short-circuits of those electrodes. Further, each of the terminal electrodes 1 to 7 includes a soldered portion (not shown) formed thereon to facilitate wiring with the exterior.

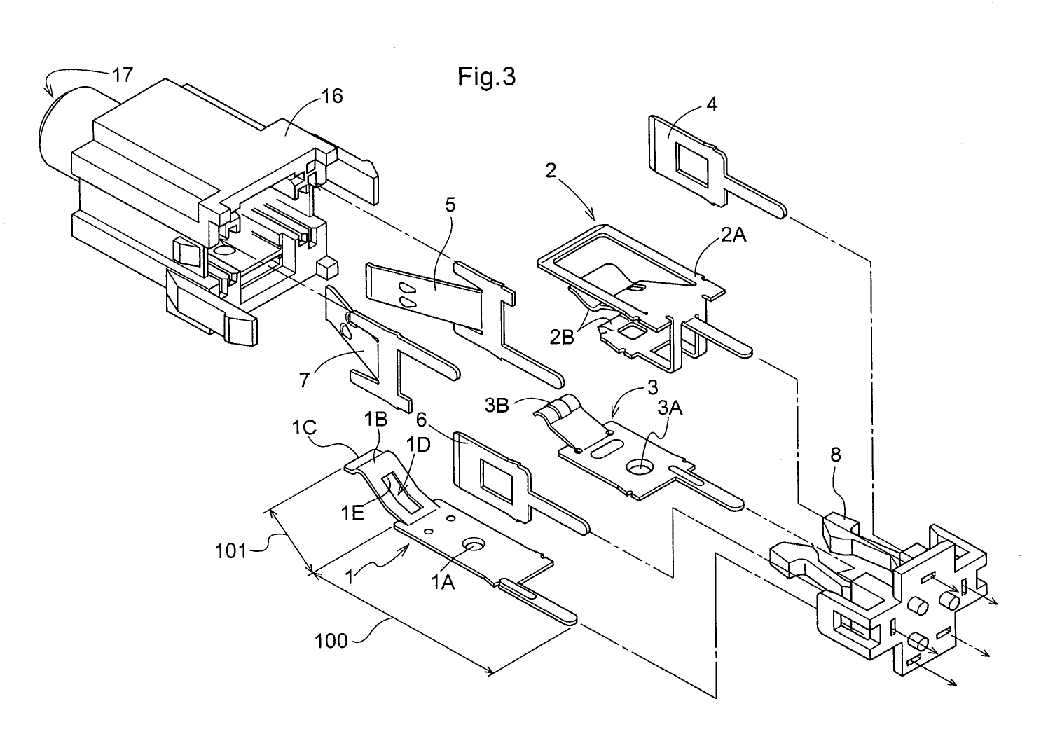

FIG. 3 is an exploded view of the jack 11 showing the terminal electrodes and the like. The jack 11 includes a spring 1, a tip spring 2, a ring spring 3, a first B-armature 4, a first T-armature 5, a second B-armature 6 and a second T-armature 7, all of which act as the electrodes. Since the sleeve 23 is connected to have the same potential as the ground as noted above, the spring 1 for contacting the sleeve 23 will be referred to as the earth spring 1 and described in detail hereinafter.

The earth spring 1 according to the present invention is movable under its spring action and includes an earth spring fixing portion 1A provided in a proximal part 100 thereof for fixing the earth spring 1 to the body 16 of the jack 11. At a free end part 101 of the earth spring is provided a pressing portion 1B which is bent for pressing a side surface of the plug 15 when the earth spring 1 contacts the sleeve 23 of the plug 15 inserted into the jack 11. Also, as shown in FIG. 3, the earth spring 1 includes a first contact portion 1C at a distal end thereof extending from the pressing portion 1B and bent at a substantially central portion thereof. Further, the free end part 101 has a slot 1D formed therein with an opening edge acting as a second contact portion 1E. As shown in FIG. 3, a boundary portion defined between the proximal part 100 and the free end part 101 is also bent. Thus, the first contact portion 1C and the second contact portion 1E are arranged along the plug inlet 17 at opposite sides of the pressing portion 1B.

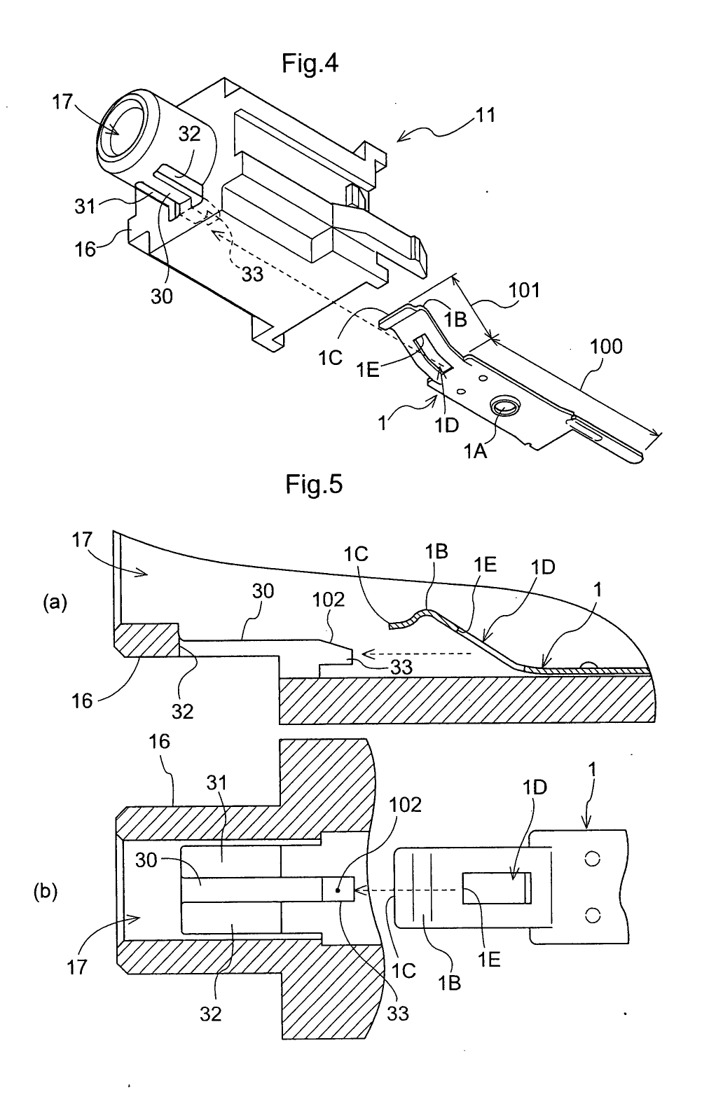

FIG. 4 is a prospective view of the jack 11 and the earth spring 1 showing the relationship therebetween. The body 16 includes a first opening 31 and a second opening 32 formed parallel to each other adjacent the inlet opening of the plug inlet 17 for receiving the plug 15. A bar 30 is formed between the first opening 31 and the second opening 32, to have a projection 33 formed at a distal end thereof to extend through the slot 1D of the earth spring 1. The bar 30 and the projection 33 act together as a guide mechanism for preventing out-of-plane displacement of the pressing portion 1B from a predetermined position where the earth spring 1 is movable with reference to the proximal part 100 when the plug 15 is inserted and the pressing portion 1B presses the side surface of the plug 15.

FIG. 5(a) is a side view of the earth spring 1 and the body 16 showing how these elements are held with each other, while FIG. 5(b) is a bottom view thereof. It should be noted that the bar 30 and the projection 33 are made of a reinforced resin. Thus, even when a torsional force occurs as the plug 15 is inserted to apply a twisting force to the earth spring 1, the projection 33 made of the reinforced resin extends through the slot 1D of the earth spring 1, which allows outer surfaces of the bar 30 and the projection 33 to act as a retaining portion 102. Not only is the plug 15 is pressed by the pressing portion 1B, both the first contact portion 1C and the second contact portion 1E contact the bar 30, thereby preventing poor contact resulting from out-of-plane displacement between the pressing portion 1B and the sleeve 23 which should properly contact each other.

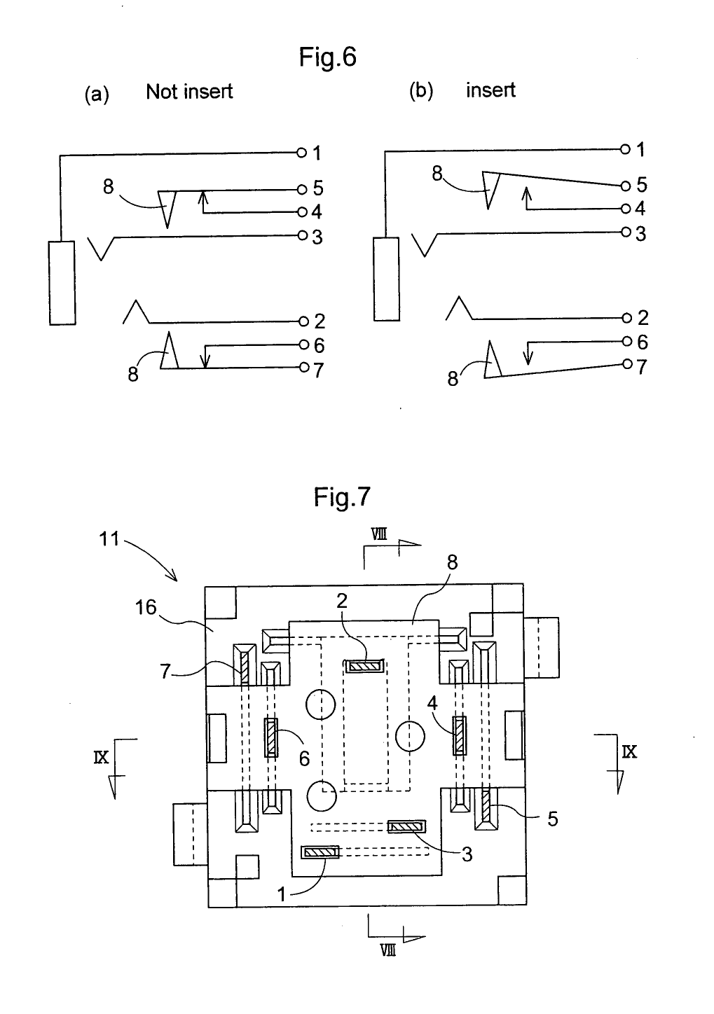

FIG. 6 is a circuit diagram showing connection among the terminal electrodes of the jack 11. As noted above, the jack 11 includes the earth spring 1, tip spring 2, ring spring 3, first B-armature 4, first T-armature 5, second B-armature 6 and second T-armature 7. When the plug 15 is not inserted into the plug inlet 17, the first B-armature 4 and first T-armature 5 are electrically connected to each other, and the second B-armature 6 and second T-armature 7 are also electrically connected to each other as shown in FIG. 6(a). On the other hand, when the plug 15 is inserted into the plug inlet 17, the first B-armature 4 and first T-armature 5 are disconnected from each other, and the second B-armature 6 and second T-armature 7 are also disconnected from each other as shown in FIG. 6(b). The details will be described later.

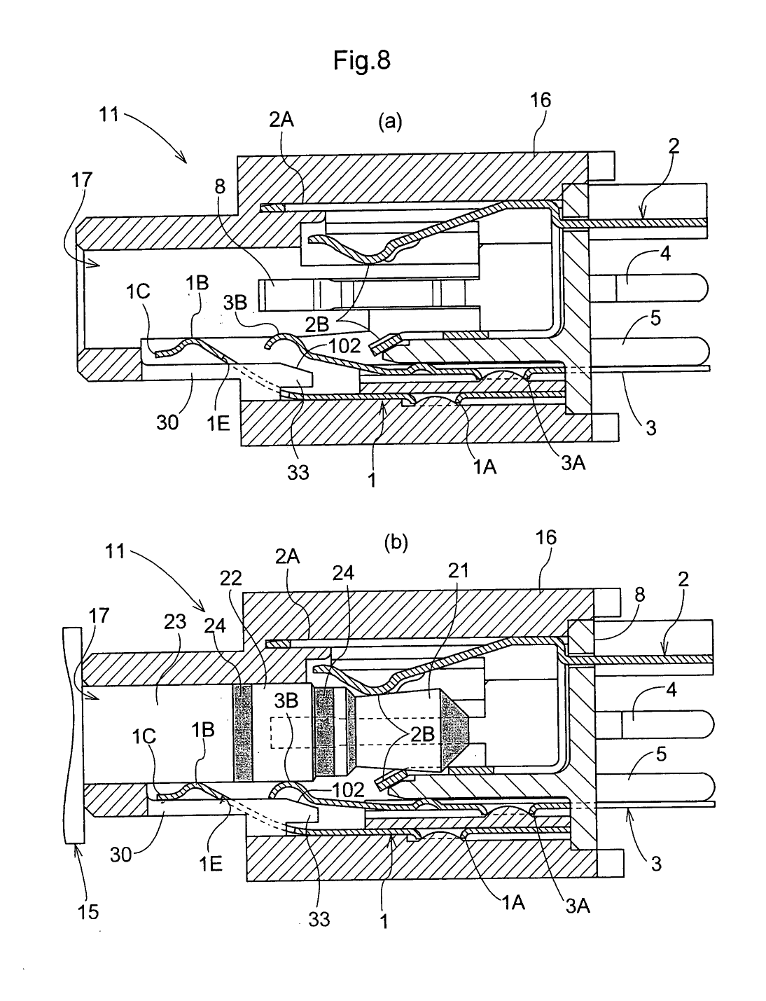

FIG. 7 shows the jack 11 viewed from the side where the terminal electrodes formed outside the jack 11 are provided (from the side facing away from the plug inlet 17 in FIG. 2). FIG. 8(a) shows the jack 11 taken along the line VIII-VIII of FIG. 7 without the plug being inserted. Inside the jack 11 are the tip spring 2 to be connected, along with the earth spring 1, to the tip 21 of the plug 15, and the ring spring 3 to be connected to the ring 22 of the plug 15. The earth spring 1 is fixed to the body 16 by the earth spring fixing portion 1A. Similarly, the tip spring 2 and ring spring 3 are fixed to the body 16 by a tip spring fixing portion 2A and a ring spring fixing portion 3A, respectively.

FIG. 8(b) shows the jack 11 taken along the line VIII-VIII of FIG. 7 with the plug being inserted. The tip 21 contacts tip contact portions 2B when the plug 15 is inserted. Then, the ring 22 contacts a ring contact portion 3B while the sleeve 23 contacts the pressing portion 1B of the earth spring 1. The earth spring 1 is pressed by the plug 15 by virtue of its spring action, whereby the first contact portion 1C and the second contact portion 1E contact the bar 30. It should be noted that a conventional jack is not provided with the second contact portion 1E, which brings the pressing portion 1B into contact the sleeve 23 and allows only the first contact portion 1C to contact the bar 30. Thus, the three points provided by the pressing portion 1B, first contact portion 1C and earth spring fixing portion 1A constitute a plate spring. On the other hand, according to the jack 11 of the present invention, the first contact portion 1C and second contact portion 1E arranged at opposite sides across the pressing portion 1B provide two points for contacting the bar 30, and these three points constitute the plate spring noted above. In comparison between the present invention and the conventional art, a distance between the pressing portion 1B and first contact portion 1C is the same while a distance between the pressing portion 1B and the earth spring fixing portion 1A in the prior art corresponds to the decreased distance between the pressing portion 1B and the second contact portion 1E in the present invention. Since the plate spring shape is formed to have a small distance, the posture of the spring is stabilized thereby to enhance the strength against torsional forces.

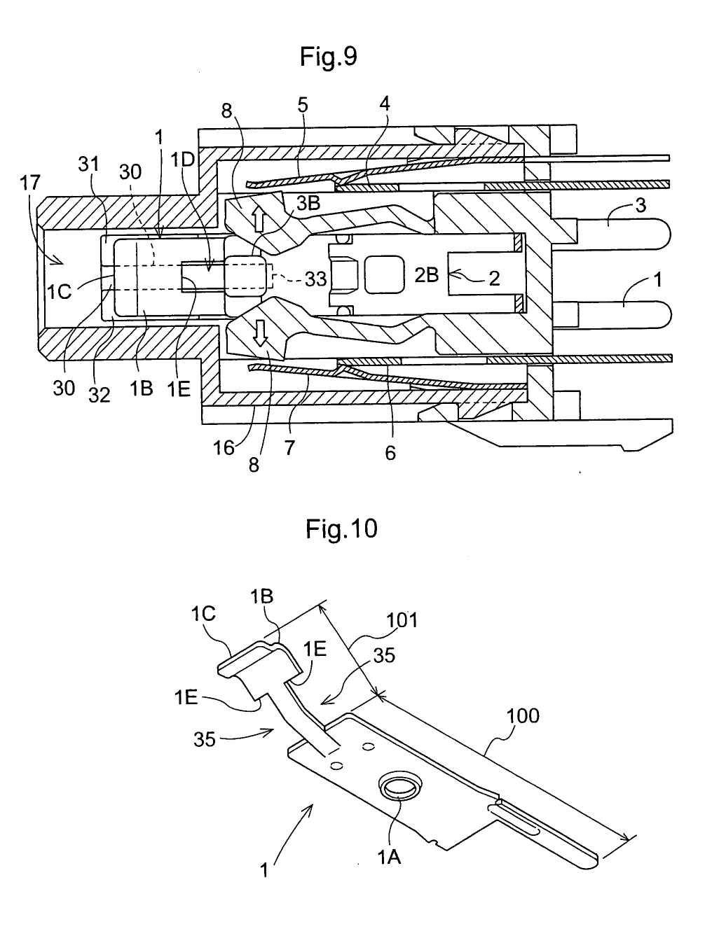

FIG. 9 is a sectional view of the jack 11 taken along the line IX-IX of FIG. 7 without the plug being inserted. The first B-armature 4 contacts the first T-armature 5 while the second B-armature 6 contacts the second T-armature 7. The separator 8 is provided in the central portion of the jack assembly. When the plug 15 is inserted, the separator 8 receives a pressing force to expand in the direction of arrows shown in FIG. 9. Due to this pressing force, the separator 8 expands the first T-armature 5 and second T-armature 7 outward. As a result, the first T-armature 5 is disengaged from the first B-armature 4 and the second T-armature 7 is also disengaged from the second B-armature 6.

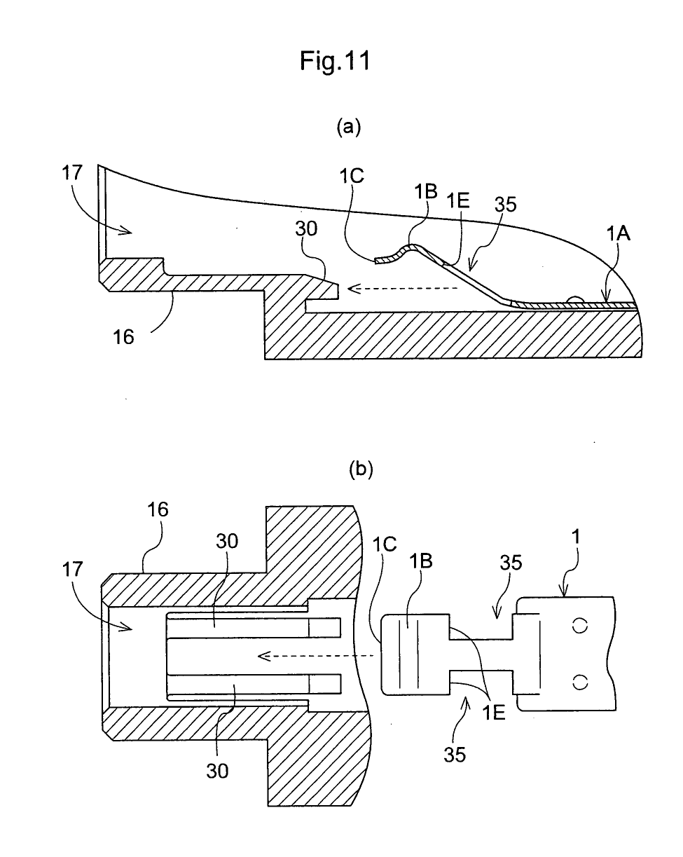

According to the above embodiment, the second contact portion is formed in the slot 1D. However, the scope of the present invention is not limited to this arrangement. Naturally, for instance, cutout portions 35 may be provided as shown in FIG. 10 instead of the opening such as the slot 1D. With such an arrangement, as shown in FIGS. 11(a) and 11(b), two bars 30 are provided to extend from the body 16 thereby to hold the earth spring 1 therebetween. This allows the pressing portion 1B to press the sleeve 23 while the first contact portion 1C and the second contact portion 1E contact the bars 30 as in the above-noted embodiment. Thus, naturally, it is possible to secure the functions and effects of the present invention for providing a countermeasure against a torsional force

In FIG. 10, the cutout portions 35 are provided at the opposite sides of the earth spring 1. However, the scope of the present invention is not limited to this arrangement. For example, it is also possible to provide a single cutout portion 35 at only one side of the earth spring 1 and dispense with the other side cutout portion 35, thereby allowing the earth spring 1 to be pressed and fixed directly to the body.

According to the first embodiment, the electrodes provided for the plug 15 include the tip 21, ring 22 and sleeve 23. However, the scope of the present invention is not limited to this arrangement. For example, even if only the two electrodes, the tip 21 and sleeve 23, are provided, it is possible, naturally, to enhance the countermeasure against a torsional force according to the present invention by using the pressing portion 1B, first contact portion 1C and second contact portion 1E. The present invention is also applicable where the number of terminal electrodes is increased as where a remote controller is provided between the earphones 14 and plug 15.

In the first embodiment, the earth spring 1 acts as one of the electrodes. However, the scope of the present invention is not limited to this arrangement. For example, the earth spring 1 may be provided to simply act as a reinforcing jig, instead of the electrode, operative against a torsional force.

According to the first embodiment, the pressing portion 1B, first contact portion 1C and second contact portion 1E contact the sleeve 30 and bar 30, respectively, to enhance the strength against a torsional force. However, the scope of the present invention is not limited to this arrangement. Naturally, for example, it is possible to allow an edge opposed to the edge of the slot 1D acting as the second contact portion 1E to act as a third contact portion and contact the bar 30, thereby enhancing the strength against a torsional force.

Further, the projection 33 acting as the guide mechanism is formed along the plug inlet 17 in the first embodiment. However, the scope of the present invention is not limited to this arrangement. For example, it is also possible to provide the projection 33 to extend across the plug inlet in a direction from an outer periphery toward the center of the plug inlet. With this arrangement, the position of the second contact portion 1E is shifted to the opposite edge of the slot 1D, which makes it possible to secure the functions and effects of the present invention for counteracting a torsional force by using the second contact portion 1E as well as the pressing portion 1B and the first contact portion 1C.

What is claimed is:

1. A jack including a plug inlet for receiving a plug having at least one electrode formed thereon for electrical signals, the jack comprising:
an elongated spring having a free end part and a proximal end part;
the free end part having a pressing portion capable of pressing a side surface of the plug;
the pressing portion having a first contact portion and a second contact portion arranged at opposite sides thereof along a direction of inserting the plug;
the proximal end part being fixed to the jack; and
a retaining portion capable of contacting the first contact portion and the second contact portion when the plug is inserted into the jack.

2. A jack as claimed in claim 1 further comprising a guide mechanism for preventing out-of-plane displacement of the pressing portion from a predetermined rocking plane defined by the spring rockable about the proximal end part when the plug is inserted into the jack.

3. A jack as claimed in claim 2, wherein the guide mechanism includes a projection provided in the jack and extending through an opening formed in the spring.

4. A jack as claimed in claim 3, wherein the projection is formed along an extending direction of the plug inlet, and wherein the retaining portion is formed on an outer surface of the projection.

5. A jack as claimed in claim 4, wherein the spring is an electrode electrically connectable to the plug.
